(19) United States
(12) Patent Application Publication
(10) Pub. No.: US 2011/0141750 A1
(43) Pub. Date: Jun. 16, 2011

(54) Track lighting fixture

(76) Inventor: Shan Chaing Lin, Lu Chu Hsiang (TW)

(21) Appl. No.: 11/902,179

(22) Filed: Sep. 19, 2007

(51) Int. Cl. F21V 19/02

(52) U.S. Cl. 362/427; 362/418

(57) ABSTRACT

A track lighting fixture comprising a power connector, an adjustable holder shell assembly connected to the power connector to hold a lamp. The adjustable holder shell includes an outer shade, a hollow rotating member, a rotary cap capped on the rotating member and coupled to the rear side of the outer shade for rotating the rotating member, and a sliding member mounted in the hollow rotating member and holding the lamp on the inside and a first guide rod extending inserted into an axial guide groove in the outer shade and a second guide rod inserted through a front notch of the hollow rotating member and movable along a spiral groove around the periphery of the hollow rotating member for causing axial movement of the sliding member and the lamp relative to the outer shade upon rotation of the rotating member by the rotary cap.

### BACKGROUND OF THE INVENTION

1. Field of the Invention

The present invention relates to a lighting fixtures and more particularly to a track lighting fixture, which allows adjustment of the position of the lamp in axial direction.

2. Description of the Related Art

A track lighting fixture is attached to a track, which conducts electricity. A track for track lighting fixture can be mounted to a ceiling or wall at the desired location. A track lighting fixture is for local illumination. Regular track lighting fixtures are commonly used for exhibition illumination application. When a track lighting fixture is attached to a track, the focal distance of the illumination of the lamp bulb is not adjustable. Therefore, when changed the interior decorations, the user must change the mounting position of the track lighting fixture as well as the track to fit the new arrangement of the interior decorations. It is inconvenient and takes much time to change the mounting position after installation of a track lighting fixture and the associating rack. Changing the mounting position of a track may damage the interior decorations.

### SUMMARY OF THE INVENTION

The present invention has been accomplished under the circumstances in view. It is one object of the present invention to provide a track lighting fixture, which allows adjustment of the focal distance of the lamp bulb conveniently.

To achieve this and other objects of the present invention, the track lighting fixture is comprised of a power connector, an adjustable holder shell assembly connected to the power connector, and a lamp installed in the adjustable holder assembly. The adjustable holder shell assembly comprises an outer shade, a hollow rotating member, a rotary cap, and a sliding member. The outer shade is a hollow cup-like shell having a front side, a rear side, an axial guide groove extending on the inside wall. The hollow rotating member is inserted through the rear side of the outer shade and rotatable relative to the outer shade, comprising at least one front notch, a spiral groove spirally backwardly extending from the at least one front notch around the periphery. The rotary cap is coaxially connected to and covered on the rotating member and coupled to the rear side of the outer shade for rotating the rotating member relative to the outer shade. The sliding member is mounted in the hollow rotating member to hold the lamp, comprising a first guide rod extending from the front side and inserted into the axial guide groove of the outer shade to guide movement of the sliding member relative to the hollow rotating member along the axial guide groove of the outer shade, and at least one second guide rod respectively inserted through the at least one front notch of the hollow rotating member and movable along the spiral groove of the hollow rotating member for causing axial movement of the sliding member along the axial guide groove of the outer shade to adjust the focal distance of the lamp upon rotation of the rotating member by the rotary cap.

### BRIEF DESCRIPTION OF THE DRAWINGS

FIG. 1 is an elevational view of a track lighting fixture in accordance with the present invention.

FIG. 2 is an exploded, partially cutaway of a part of the adjustable holder shell assembly of the track lighting fixture in accordance with the present invention.

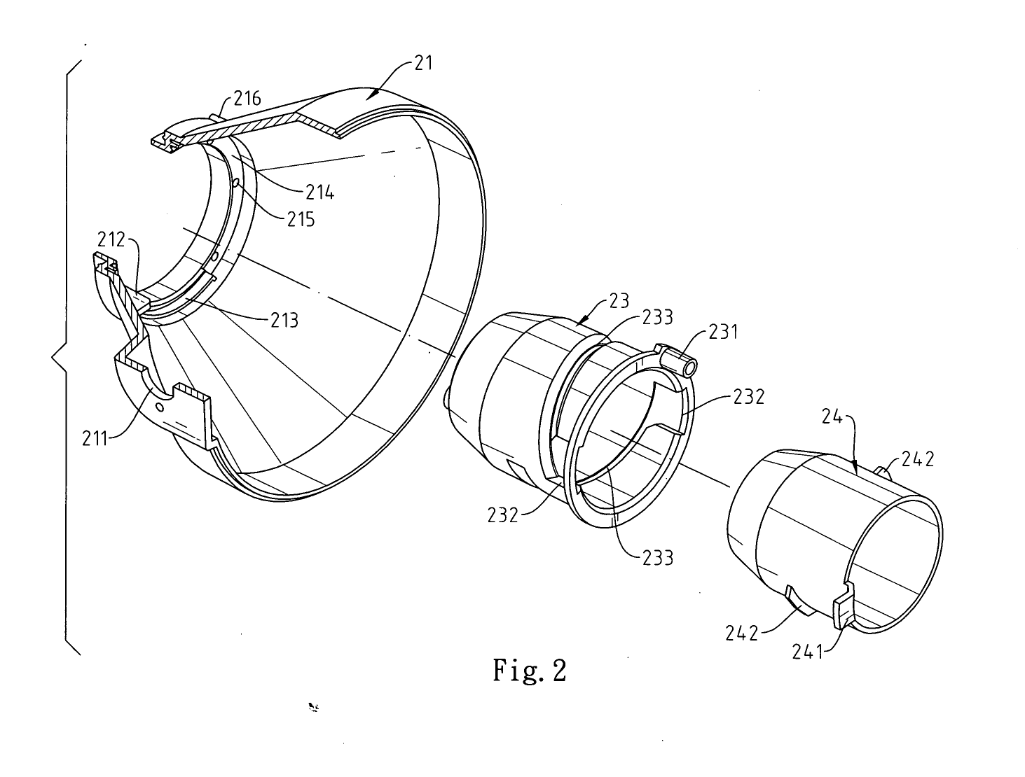

FIG. 3 is an exploded view of the adjustable holder shell assembly of the track lighting fixture in accordance with the present invention.

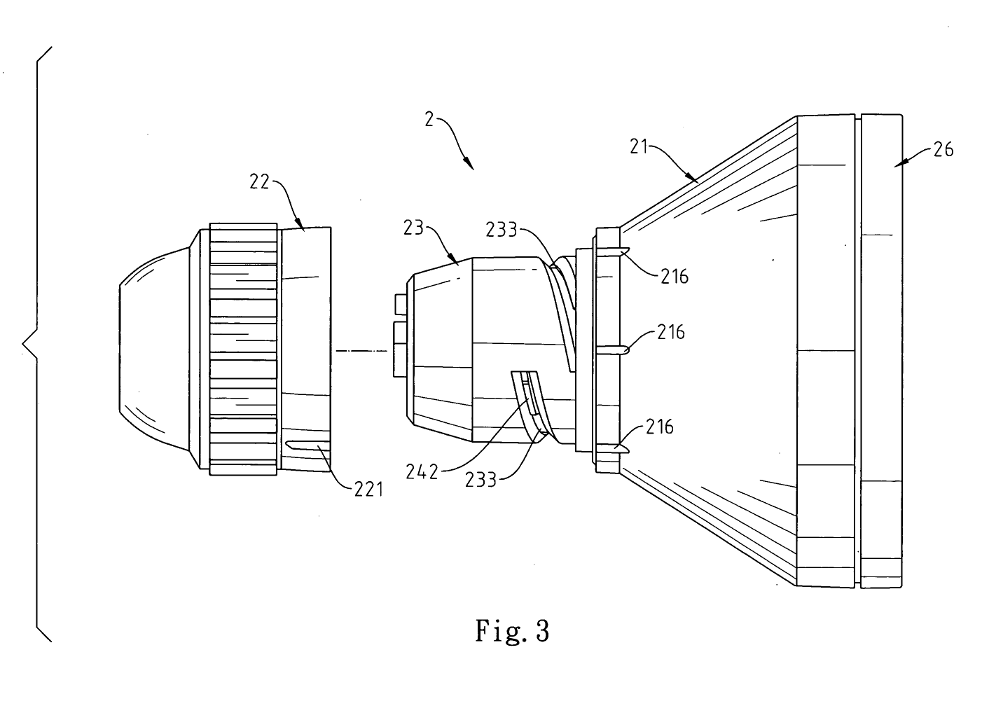

FIG. 4 is a sectional view of the track lighting fixture in accordance with the present invention.

FIG. 5 is a schematic drawing of the present invention, showing the position of the lamp adjusted.

### DETAILED DESCRIPTION OF THE PREFERRED EMBODIMENT

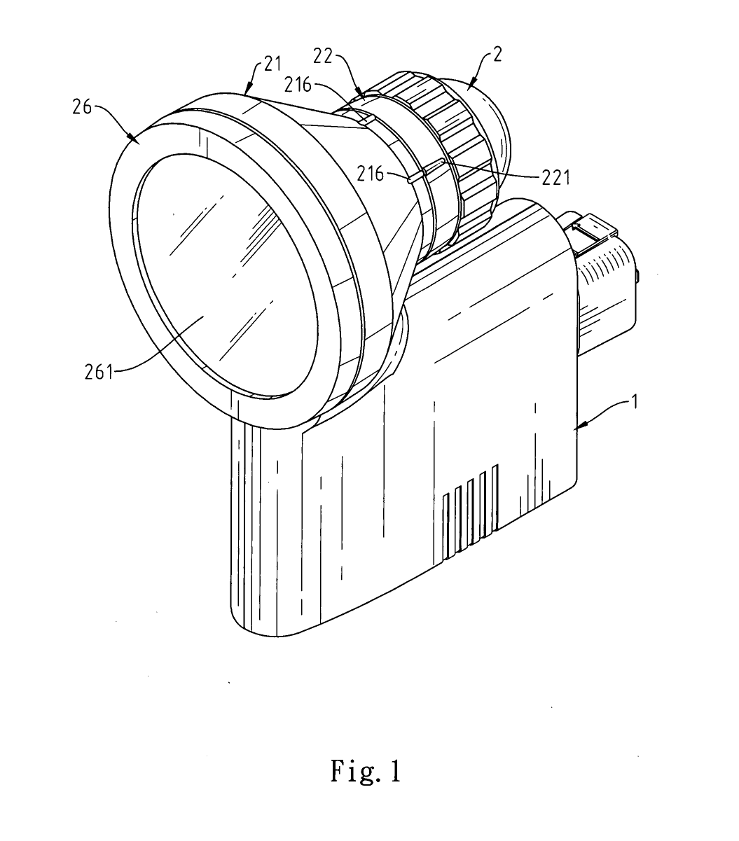

Referring to FIGS. 1˜4, a track lighting fixture in accordance with the present invention is shown comprised of a power connector 1, an adjustable holder shell assembly 2 coupled to the power connector 1, and a lamp 3 installed in the adjustable holder assembly 2.

Referring to FIG. 1 again, the power connector 1 and the adjustable holder shell assembly 2 are pivotally connected together, and the power connector 1 is electrically connected to the lamp 3 to provide the lamp 3 with the necessary electric power.

Referring to 2˜4 again, the adjustable holder shell assembly 2 is pivoted to the power connector 1, comprised of an outer shade 21, a rotary cap 22, a hollow rotating member 23, a sliding member 24, a reflector 25, and a front cap 26.

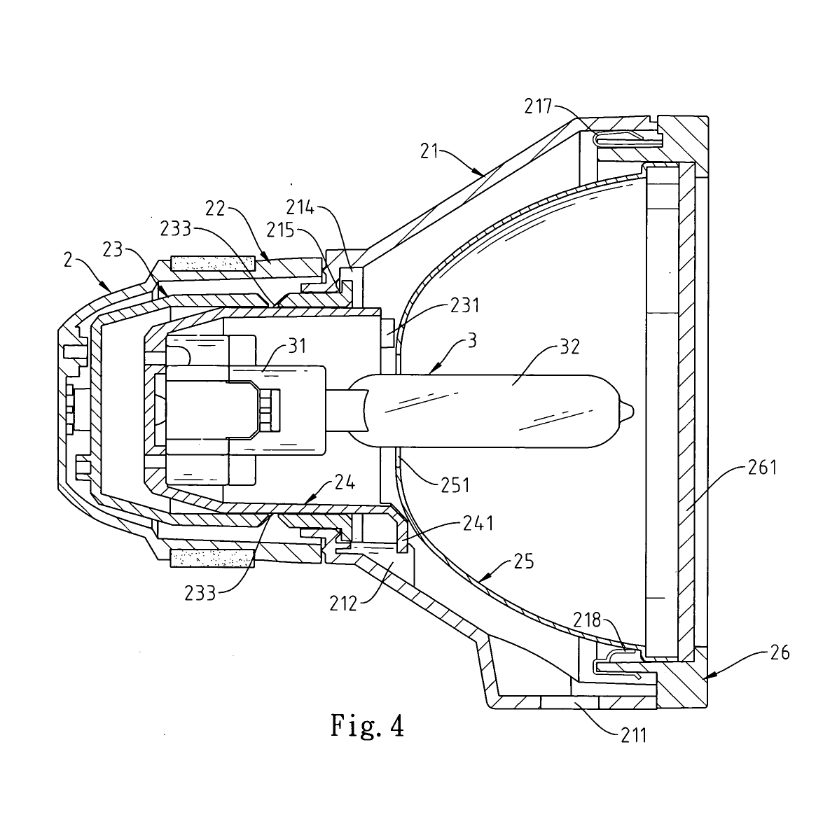

The outer shade 21 is a hollow cup-like shell having a coupling hole 211 transversely cut through the periphery and pivotally coupled to the power connector 1, an axial guide groove 212 extending on the inside wall, a semicircular baffle 213 protruded from the inside wall and suspending in one end, namely, the rear end, a guide way 214 defined in the rear end between the two distal ends of the semicircular baffle 213, a plurality of raised positioning portions 215 disposed in the guide way 214, a plurality of alignment ribs 216 protruded from the periphery corresponding to the raised positioning portions 215, and a plurality of front cap retaining lugs 217 and reflector retaining lugs 218 protruded from the inside wall near the other end, namely, the front end (see FIG. 4). The reflector 25 is mounted inside the outer shade 21 and fastened to the reflector retaining lugs 218, having a center through hole 251 (see FIG. 4). The front cap 26 is capped on the front side of the outer shade 21 and secured to the front cap retaining lugs 217. Further, the front cap 26 holds a lens 261 that blocks the front side of the outer shade 21. The hollow rotating member 23 is inserted through the rear end of the outer shade 21. The rotary cap 22 is coaxially connected to and covered on the hollow rotating member 23 and coupled to the rear end of the outer shade 21 such that the hollow rotating member 23 is rotatable by the rotary cap 22 relative to the outer shade 21. The rotary cap 22 has an alignment rib 221. The hollow rotating member 23 has a positioning rod 231 protruded from the periphery of the front side and inserted into the guide way 214 in the outer shade 21 and movable with the hollow rotating member 23 along the guide way 214 to selectively engage one of the raised positioning portions 215, at least one, for example, two front notches 232, and a spiral groove 233 extending spirally backwards from the front notches 232 around the periphery toward the rear side. The sliding member 24 is inserted into the rotating member 23, comprising a first guide member 241 protruded from the front side, and at least one, for example, two second guide rods 242. The second guide rods 242 are inserted into the front notches 232 and movable along the spiral groove 233. The first guide member 241 is engaged into the guide groove 212 of the outer shade 21.

Referring to FIG. 4 again, the lamp 3 is installed in the adjustable holder shell assembly 2, comprised of a lamp socket 31 and a lamp bulb 32. The lamp socket 31 is fixedly fastened to the inside of the sliding member 24. The lamp bulb 32 is connected with its one end (the base) to the lamp socket 31 and electrically connected to the power connector 1. The other end of the lamp bulb 32 is inserted through the center through hole 251 of the reflector 25 and suspending inside the reflector 25.

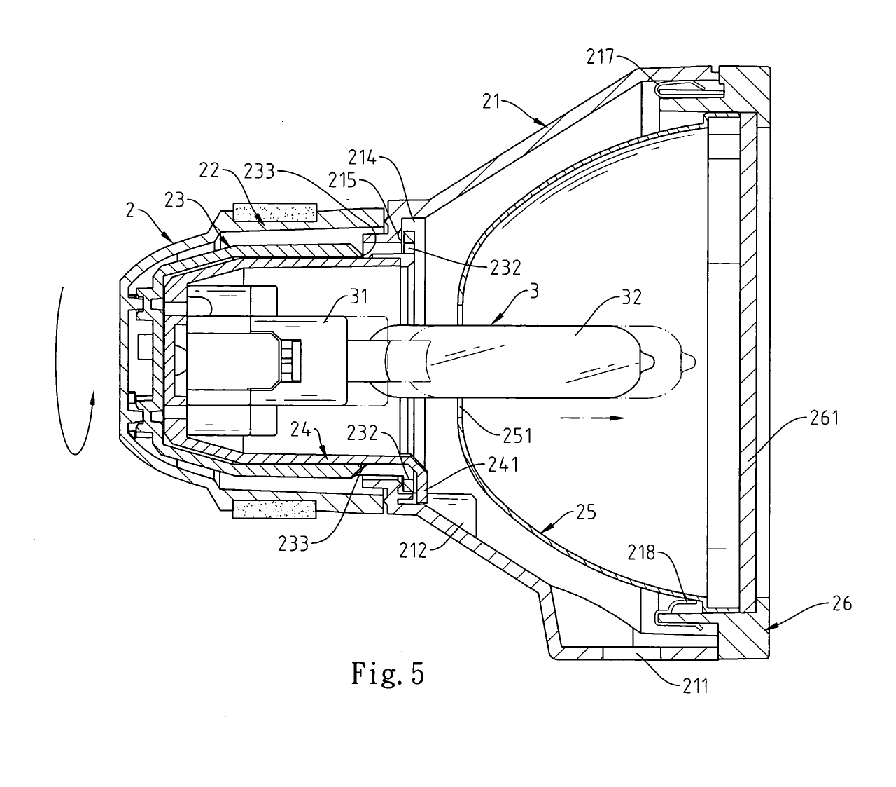

Referring to FIG. 5 and FIG. 4 again, when the user rotate the rotary cap 22 clockwise or counter-clockwise, the hollow rotating member 23 is rotated with the rotary cap 22 relative to the outer shade 21, causing movement of the second guide rods 242 of the sliding member 24 along the spiral groove 233 and displacement of the first guide rod 241 along the axial guide groove 212, and therefore the lamp 3 is moved with sliding member 24 axially forwards or backwards relative to the outer shade 21. When operating the rotary cap 22 to rotate the hollow rotating member 23 relative to the outer shade 21, the positioning rod 231 is selectively forced into engagement with one of the raised positioning portions 215 to secure the hollow rotating member 23 to one of a series of positions relative to the outer shade 21, and at the same time the alignment rib 221 of the rotary cap 22 is aligned with one of the alignment ribs 216 of the outer shade 21.

Although particular embodiments of the invention have been described in detail for purposes of illustration, various modifications and enhancements may be made without departing from the spirit and scope of the invention.

What the invention claimed is:

1. A track lighting fixture comprising a power connector, an adjustable holder shell assembly connected to said power connector, and a lamp installed in said adjustable holder assembly, wherein said adjustable holder shell assembly comprises:
an outer shade, said outer shade is a hollow cup-like shell having a front side, a rear side, an axial guide groove extending on an inside wall thereof;
a hollow rotating member inserted through the rear side of said outer shade and rotatable relative to said outer shade, said rotating member comprising at least one front notch, a spiral groove spirally backwardly extending from said at least one front notch around the periphery thereof;
a rotary cap coaxially connected to and covered on the rotating member and coupled to the rear side of said outer shade for rotating said rotating member relative to said outer shade; and
a sliding member mounted in said hollow rotating member to hold said lamp, said sliding member comprising a first guide rod extending from a front side thereof and inserted into the axial guide groove of said outer shade to guide movement of said sliding member relative to said hollow rotating member along said axial guide groove of said outer shade, and at least one second guide rod respectively inserted through the at least one front notch of said hollow rotating member and movable along the spiral groove of said hollow rotating member for causing axial movement of said sliding member along said axial guide groove of said outer shade upon rotation of said rotating member by said rotary cap.

2. The track lighting fixture as claimed in claim 1, wherein said outer shade has a coupling hole cut through the periphery thereof and pivotally coupled to said power connector.

3. The track lighting fixture as claimed in claim 1, wherein said outer shade comprises a semicircular baffle protruded from the inside wall in the rear side, a guide way defined in the rear side between two distal ends of said semicircular baffle for guiding rotation of said hollow rotating member relative to said outer shade, and a plurality of raised positioning portions disposed in said guide way for the positioning of said hollow rotating member.

4. The track lighting fixture as claimed in claim 1, wherein said outer shade comprises a semicircular baffle protruded from the inside wall in the rear side, a guide way defined in the rear side between two distal ends of said semicircular baffle for guiding rotation of said hollow rotating member relative to said outer shade, a plurality of raised positioning portions disposed in said guide way for the positioning of said hollow rotating member, and a plurality of alignment ribs protruded from the periphery corresponding to said raised position portions for indicating angular position of said rotary cap.

5. The track lighting fixture as claimed in claim 1, wherein said outer shade comprises a semicircular baffle protruded from the inside wall in the rear side, a guide way defined in the rear side between two distal ends of said semicircular baffle for guiding rotation of said hollow rotating member relative to said outer shade, a plurality of raised positioning portions disposed in said guide way for the positioning of said hollow rotating member, and a plurality of alignment ribs protruded from the periphery corresponding to said raised position portions for indicating angular position of said rotary cap said rotary cap comprises an alignment rid protruded from the periphery thereof for alignment with one of the alignment ribs of said outer shade; said hollow rotating member comprises a positioning rod protruded from a front side thereof and inserted into the guide way of said outer shade and movable along the guide way of said outer shade to guide rotation of said hollow rotating member relative to said outer shade between the two distal ends of said semicircular baffle, the positioning rod of said hollow rotating member being movable with said hollow rotating member for engaging one of said raised position portions of said outer shade.
